(19) United States
(12) Patent Application Publication
(10) Pub. No.: US 2015/0100227 A1
(43) Pub. Date: Apr. 9, 2015

(54) METHOD FOR EXPANDING AIRCRAFT CENTER OF GRAVITY LIMITATIONS

(71) Applicant: C. Kirk Nance, Keller, TX (US)

(72) Inventor: C. Kirk Nance, Keller, TX (US)

(21) Appl. No.: 14/509,482

(22) Filed: Oct. 8, 2014

Related U.S. Application Data
(60) Provisional application No. 61/888,705, filed on Oct. 9, 2013.

(51) Int. Cl. G01M 1/12; B64D 45/00

(52) U.S. Cl. CPC G01M 1/125; B64D 45/00
USPC 701/124

(57) ABSTRACT

A method which creates a justification basis to expand an aircraft's Center of Gravity limitations, which are established by the aircraft designer; relating to aircraft landing gear strength assumptions. Strut load sensors such as pressure sensors are mounted in relation to each of the landing gear struts to monitor, measure and record aircraft landing gear strut compression loads. A history of measured landing gear load values is compiled and related to any assumed landing gear loads, which define the life-cycle limit of the landing gear, allowing relief from existing aircraft Center of Gravity limitation caused by landing gear strength assumptions to further expanded CG limitations beyond current limits, based on measured landing gear loads.

### SPECIFICATION

This application claims the benefit of U.S. provisional patent application Ser. No. 61/888,705, filed Oct. 9, 2013.

### FIELD OF THE INVENTION

The present invention relates to aircraft centers of gravity.

### BACKGROUND OF THE INVENTION

There are many critical factors the pilot of an aircraft must consider when determining if the aircraft is safe for takeoff. One of those factors includes identifying the Center of Gravity hereinafter referred to as “CG” for the aircraft.

The CG is the center of balance of the aircraft. The position of the CG has to stay within certain limits to ensure aircraft maneuverability, stability and also the aircraft structure integrity.

In the examples given all limitations and definitions related to aircraft weight and balance aspects (the us of the word “balance” typically refers to “CG”) use what is called the Mean Aerodynamic Chord (MAC) or the Reference Chord (RC). For example, the position of the CG is usually expressed in terms of percentage of MAC. The safe limits for the CG are also expressed in tears of percentage of MAC (the symbol used is % MAC)

The MAC is a reference line used in the design of the wing, and its position relative to the wing and the fuselage is accurately known.

As an aircraft takes off, it rolls along a runway increasing speed. When the aircraft reaches a speed sufficient to create the desired amount of lift, the aircraft nose is rotated, wherein the aircraft leaves the ground. CG plays an important role in aircraft rotation. An aft CG position Rives the aircraft a nose-up attitude that helps the rotation. On the contrary, a forward CG position leads to a nose-heavy situation and a difficult rotation. When determining the aircraft takeoff performance the calculation is always performed at the most forward and certified CG position.

The aircraft CG limits are defined and vary according to aircraft loading and taxi limitations, as well as each flight phase: takeoff, in-flight, and landing. The CG limits are mainly due to: airframe structural limitations, in-flight handling qualities, and ground loads experienced by the aircraft landing gear.

Certain Federal Aviation Regulatory Authority rules have to be respected when designing a weight and CG envelope. The extreme forward and the extreme aft CG limitations must be established for each practicably and separable operating condition. No such limits may lie beyond:
1. the extremes selected by the aircraft designer,
2. the extremes within which the structure integrity is proven,
3. the extremes within which compliance with each applicable flight and ground handling requirement is shown.

Generally speaking the airplane must be safely controllable and maneuverable during: loading, taxi, takeoff, climb, level flight, descent, landing and post-flight taxi. It must be possible to make a smooth transition from one flight condition to any other flight conditions without exceptional piloting skill, alertness, or strength, and without danger of exceeding the airplane limit-load factor under any probable operating conditions including: the sudden failure of the critical engine, configuration changes including deployment or retraction of deceleration devices, pre-flight taxi and takeoff limitations which are related to aircraft component structural limitations. Consideration for the aft CG operational limitation may be best described from the following excerpt from an Airbus Industries publication:
Flight Operations Support and Line Assistance
“Getting to Grips with Weight and Balance”
Customer Services Publication—Airbus
Page 101
Section A—“Generalities”
Subparagraph b)

b) Aft limit

The design of the aft limit takes into account the following:
Main gear strength
Nose gear adherence
Take-off rotation (Tail strike)
Stability in steady flight and during maneuvers
Go-around and Alpha Floor (final approach in case of emergency landing).
Those limitations are classified as handling quality and structural limitations

For aft CG limits, there is no need for a compromise between loading operations and performance. Only the structural limitations and the handling quality will be taken into account when establishing the aft limit of the CG envelope.

An aircraft weight and balance envelope is a 2-dimensional polygon (see. FIG. 2a) which defines the aircraft's weight and CG limitations. Aircraft weight and CG must remain within the boundaries of the polygon. The example in FIG. 2a illustrates dashed lines for the forward limits, as well as top and lower limits. The solid lines represent the aft CG limits, which will be discussed in more detail within this specification.

These limitations fall into three primary categories:
1. main landing gear strength,
2. aircraft “in-flight” handling, at “low air-speeds”
3. aircraft “ground” handing, to insure the aircraft nose is not “too light” that the nose gear steering would lose traction with the ground

The aircraft loading, taxi and takeoff CG limitations are the focus of this invention, and in particular the aft CG limitation of aircraft loaded near the higher weight limitations.

The aircraft weight and CG envelope typically starts as a chart with the vertical axis of the chart related to aircraft weight and the horizontal axis related to forward and all CG limitations (for example, see FIG. 2). The higher the position is within the chart, the heavier the aircraft. Nose heavy aircraft identify the CG in the left/forward side of the chart. Tail heavy aircraft identify the CG in the right/aft side of the chart. Limitations as described above will curtail or restrict various sections or areas from the chart, so that the aircraft cannot be operated with the CG located in a curtailed or restricted section of the chart. When the aircraft CG is aft, a larger percentage of the aircraft weight is supported by the main landing gear. Landing gears are the second most expensive component on the aircraft second only to the aircraft engines. Numerous aircraft designs have the aft CG limitation curtailed, at higher weight ranges, due to assumptions of “main landing gear strength.” This curtailment is based on assumptions made as to loads which are applied to the landing gear, through the typical 80,000 cycle life of the aircraft and landing gear. One might assume that hard landing events generate loads to the landing gear which define the limitations on the landing gear. This is not the case. Typically main landing gear see higher loads on takeoff just prior to rotation, when the aircraft is the heaviest while carrying a full fuel load, traveling down the runway, rolling across the bumps created by expansion joints in the concrete runway. As the aircraft taxis from the gate and accelerates down the runway for the takeoff run, these high loads applied to the landing gear struts are the primary load assumptions that determine the limitations related to the main and nose landing gear strength. It is not the extremes of periodic hard landing events which generate the most damage to a landing gear strut, but the thousands of higher weight taxi events that produce the greater burden on the fatigue-life of the landing gear components. An extensive modeling profile of these “assumed” higher loads influence the manufacture's design criteria for the landing gear struts.

Fuel is the most costly item in an airline's annual expenses. Airline profit margins arc slim at best, so any and all efforts must be used to reduce fuel consumption. Aircraft CG location affects the amount of fuel which the aircraft burns. If an aircraft is loaded with the CG positioned towards the forward limit of the aircraft's CG envelope, the pilot must apply additional rear stabilizer trim to maintain proper balance for the nose-heavy aircraft. This additional rear stabilizer trim will increase the aerodynamic drag on the aircraft, thus burn more fuel. If an aircraft can be loaded with the aircraft CG positioned near the aft limit of the aircraft CG envelope, the aircraft will require less rear stabilizer trim, thus creating less aerodynamic drag; therefore be more fuel efficient. It is to the benefit of the airline to load the aircraft close to the aft CG limit, without exceeding that aft limitation. On many aircraft types, the aft limitation is not predicated on aircraft stability, handling or flight characteristics; it is limited based upon the assumption of main landing gear strength, throughout the possible loads applied to that landing gear over its 80,000 cycle life. Reference may be made again to Airbus Aircraft Industries, Customer Services—Flight Operations Support & Line Assistance “Getting to Grips with Weight and Balance” publication. Pages 45-47, 98-106 of this publication define and illustrate that at higher aircraft weight, the aft CG limitation is reduced/curtailed due to main landing gear strength.

Aircraft designers understand that the main landing gear strength limitation could be removed from the higher weight, aft CG positioning if the manufacture would design and install a more robust main landing gear. It is understood that the higher loads associated with a more aft CG are merely just higher proportional loads placed onto the main landing gear due to the main landing gear supporting a larger percentage of the total aircraft weight. Again it should be realized that landing gear strength is another way of describing landing gear reliability, considering the assumed loads are allocated against the defined fatigue-life limit which is designed into the landing gear strut.

Aircraft weight assumptions also affect the margins aircraft designers must assign to landing gear strength calculations, due to concerns that various passenger and baggage weight assumptions may be incorrect. As an example, the Boeing 737-800 aircraft allows for 189 passengers to be loaded within a single class configuration of the aircraft passenger compartment. The Federal Aviation Administration Advisory Circular AC-120-27E, page 20 identifies regulatory guidelines for average passenger weights, during winter months, at 189 lb. Federal Aviation Administration defined passenger weight assumptions can allow un-recognized statistical errors up to 4% in the random chance that some flight might have a higher populations of over-weight passengers; the 189 passenger count multiplied times the maximum number of passengers, further multiplied times a 4% error; would have an additional 1,429 pounds of weight applied to the aircraft. The additional 1,429 pounds of un-recognized weight suggests that with the aircraft CG located at its most aft current limits using current methods of weight determinations, and assuming the weight is equally distributed across the lateral plane of the two main landing gear, would have an additional 714 pounds of non-recognized weight applied to each respective main landing gear strut.

Additional errors which might induce higher weights/loads onto each respective main landing gear strut would be the potential of incorrect fuel measurements and further unknown loads from potential fuel imbalance between the left and right fuel tanks located within each wing. Aircraft fuel is pumped into both sides of the aircraft wing tanks through flow meters measuring gallons for liters) pumped. Once the fuel is onboard the aircraft, the aircraft fuel indicators, through the use of embedded density compensators, convert the fuel load from gallons into pounds (or kilograms). Fuel volume is typically converted to weight at a conversion rate of 6.8 pounds per gallon. Depending upon the temperature of the fuel, the fuel volume will expand at higher temperatures and contract at lower temperatures. Though the volume as measured in gallons might have changed, the weight remains the same. The aircraft's fuel indicator's density compensators typically have an allowed error of ±2%. The maximum fuel load on the Boeing 737-800 is 46,750 pounds of fuel. Considering the 2% potential error in the density compensations, the total fuel load could have a weight error as high as 935 pounds, assuming the fuel was perfectly balance between the left and right fuel tanks, this could have an additional 468 pounds of non-recognized weight applied to each respective main landing gear strut. Considering a potential fuel loading imbalance of 10%, another 47 pounds of error would have to be added. Having all of these weight errors applied to a single main landing gear strut would total:

| | | |
|---|---|---|
| Passenger weight error | 714 | pounds |
| Fuel density weight error | 468 | pounds |
| Fuel imbalance weight error | 47 | pounds |
| Total weight error | 1,229 | pounds |

Considering the example with the Boeing 737-800 aircraft with a takeoff weight of 174,000 pounds, moving the aircraft CG aft from the current limit of 27.36% MAC to 36.00% MAC, being a movement of 13.4 inches further aft, will increase the weight applied to a respective main landing gear by 1,902 pounds. This identifies that 65% of the weight increase onto the main landing gear struts, created by the further aft location of aircraft CG, is a real potential and most likely occurring in today's airline operations. Currently however, these errors are not recognized. Having and using a means to measure and monitor the precise loads applied to each respective main landing gear, over its 80,000 cycle lifetime, will provide aircraft designers the assurances they can allow aircraft operators the ability to utilize the further aft portions of the CG envelope, without risk of main landing gear strut failures.

Aircraft designers have not been willing to install more robust landing gear on aircraft, just to eliminate this aft CG curtailment. What the aircraft designers have failed to realize is that the main landing gear strength limitation to the aft portion of the CG limitation can be removed, without the requirement of installing a stronger main landing gear strut. The large curtailment of the aft limitation of CG for heavier aircraft is based on the assumed life limitation of the main landing gear. Another obvious example of this is with the Airbus 320 Series aircraft. The 320 Series include the A-318, A-319, A-320 and A-321. All of these aircraft use the same main landing gear strut. All of these aircraft have common flight characteristics. The A-320 was the initial version of the Series. The A-319 was developed with a shorter fuselage, with a lower Max Takeoff weight limitation. The A-321 was developed with an extended fuselage, with a higher Max Takeoff weight limitation. The A-318 was developed to compete against the smaller commuter aircraft, where the fuselage is manufactured even shorter than the A-319 and this version within the Series has the lowest Max-Takeoff weight. The A-319, A-320, and A-321 all have the at CG limitation curtailment due to main landing gear strength, but the lower weight A-318 does not have any aft CG curtailment due to landing gear strength issues (see FIG. 4b). Reference again made to the Airbus Aircraft Industries, Customer Services—Flight Operations Support & Line Assistance “Getting to Grips with Weight and Balance” publication. Pages 45-47. The reason the A-318 does not have the aft CG curtailment is because the main landing gear used on this airframe was initially designed for the larger and heavier A-320 version of this aircraft family, thus the main landing gear strength assumption limitation for the A-318 does not apply. This reveals that the aft CG limit curtailment for main landing Rear strength for the A-319/320/321 aircraft were not subject to aircraft flight stability, nor issues of safe flight, but rather the limitation of the fatigue-life of the main landing gear, as it must endure through the 80,000 takeoff and landing cycles limiting the A-320 Series aircraft. Use of this new invention allows for thousands of measured load events to be recorded during in each flight cycle. The landing gear life limitation is defined by assumptions as to the millions of different load events which will be experienced by the landing gear. Once an aircraft is sold and delivered to an airline, neither the landing gear manufacturer nor the aircraft manufacturer can control the amounts and/or durations of loads applied to any landing gear in service, therefore they must make assumptions as to the potential loads expected by the landing gear throughout its life. Where some airlines might have better maintenance procedures and operate from airports which have better maintained runways and taxi-ways, and other airlines might operate on tighter maintenance budgets and operated at airports with lesser taxi-way and runway requirement and maintenance standards. These lesser maintained airports may have uneven “expansion joint seams” within the concrete that make-up the runways and taxi-ways. These uneven or gapped expansion joints will induce greater loads onto the landing gear as the aircraft taxi at heavy weights and/or accelerate through the takeoff roll. Aircraft manufacturers cannot control which airports from which the aircraft they manufacture and deliver will operate from; thus the aircraft manufacturers must make extreme assumptions for landing gear loads to insure that a worst case scenario will not result in a landing gear &Hum Which will open an enormous amount of liability towards the aircraft manufacturer. Thus the aircraft manufacturer must design for the worst and hope for the best.

Today, aircraft used in airline operations have What designers and aviation Regulators call a Limit Of Validity “LOV” on major components for the aircraft. These major components include among others, the fuselage of the aircraft and the landing gear. An example of what influences the LOV is the Apr. 28, 1988 Aloha Airlines Flight #243 accident, where the front cabin roof section of the aircraft ripped off during flight, caused by an explosive decompression created by metal fatigue failure. Historically aircraft life limitations were calculated based on the number of hours flown by the aircraft. In the case of the Aloha flight, that aircraft had a relatively low number of flight hours at 35,496 hours; but had an extremely high number of take-off and landing cycles at 89,680 flight cycles. The reason the fuselage failed is because of the high number of compression and decompression events that aircraft had experienced over the 89,680 cycles, had weakened the aluminum rivet connections for the aircraft structure, and the fuselage section failed. That event prompted Regulators to limit the number of flight cycles, regardless of a lower number of flight hours. With the Boeing 737 “Next Gen”, the LOV for that aircraft fuselage is 80,000 cycles.

Other aircraft components, such as the landing gear, must have a LOV for the number of landing cycles they experience. Aircraft designers attempt to have the LOVs of both the aircraft and the landing gear to match, thus the LOV for the Boeing 737 family of aircraft landing gear is 80,000 cycles.

The Boeing 737 “Next Gen” family comes in various sizes being the -600, -700, -800. -900; each progressively longer than its predecessor. As the aircraft gets longer, the aircraft typically get heavier. The Boeing 737-600 which has a maximum take-off weight of 145,500 pounds has the same landing gear as the heavier Boeing 737-800 which has a maximum take-off weight of 174,200 pounds. To keep a common life cycle landing gear LOV of 80,000 cycles for both of these airframes (which both have aircraft LOV of 80,000 cycles) the landing gear loads on the -800 must be reduced by avoiding the potential that a higher percentage of the aircraft's weight is applied to either the nose or main landing gear struts; thus the restriction or curtailment of the CG envelope at the higher aircraft weights. This invention allows for measured landing gear loads to be used, as a justification basis to reduce the forward and at CG curtailments, and still allow safe operation of the aircraft, by either documenting lower landing gear loads, or by shortening the landing gear LOV from 80,000 cycles, to a number of cycles equivalent with the measured loads experienced.

There are numerous prior art technologies which monitor loads applied to and experienced by aircraft Landing gear, but there are no prior art systems which monitor landing gear strut loads being utilized in any of today's airline operations. Installation or a landing gear load monitoring system upon the initial delivery of the aircraft which monitors Landing gear kinds throughout the life of the landing gear strut would allow the aft CG limitation curtailment, due to concerns of assumed landing gear strength (where the word strength is used to describe landing gear fatigue-life), to be removed. With the aft CG limit curtailment due to landing gear strength removed, the aft CG limitation would be determine by aircraft handling and performance criteria instead of the main landing gear strength assumptions, and the aircraft could still be safely operated with its CG located further aft at higher weights.

### SUMMARY OF THE INVENTION

A method expands a center of gravity (CG) limitation of an aircraft. The aircraft has landing gear struts. The aircraft has a first CG limitation that is determined by a designer of the aircraft. The first CG limitation is based upon assumed loads on the landing gear struts. The method operates the aircraft and during the operation of the aircraft, measures the loads on the landing gear struts. The method determines if the measured loads have exceeded their assumed loads. If the measured loads have not exceeded their assumed loads, then a second CG limitation is determined, which exceeds the first CG limitation. The aircraft is operated at an expanded CG that exceeds the first CG limitation but is within the second CG limitation.

In accordance with one aspect of the present invention, the step of measuring the loads on landing gear struts further comprises the step of measuring pressure of the landing gear struts.

In accordance with another aspect of the present invention, the step of measuring the loads on landing gear struts further comprises the step of measuring acceleration of the landing gear struts.

In accordance with another aspect of the present invention, the step of measuring the loads on landing gear struts further comprises the step of measuring strain in the landing gear struts.

In accordance with another aspect of the present invention, continuing to measure the loads on the landing gear struts while operating the aircraft at the expanded co to determine a load history of the landing gear struts.

In accordance with another aspect of the present invention, comparing the measured loads applied on the landing gear struts with the assumed loads on the landing gear struts, to further identify any exceedance.

In accordance with another aspect of the present invention, comparing the measured loads applied on the landing gears with the assumed loads on the landing gear struts to verify landing strength assumptions have not been reached or exceeded.

In accordance with another aspect of the present invention, if the measured loads have exceeded the revised assumed loads, then reducing a life limit of the landing gear struts or reducing the expanded CG limitation.

In accordance with another aspect of the present invention, the first and second CG limitations are aft CG limitations.

In accordance with another aspect of the present invention, operating the aircraft at the expanded CG consumes less fuel than operating the aircraft at a CG that is within the first CG limit.

### BRIEF DESCRIPTION OF THE DRAWINGS

Although the features of this invention, which are considered to be novel, are expressed in the appended claims; further details as to preferred practices and as to the further objects and features thereof may be most readily comprehended through reference to the following description when taken in connection with the accompanying drawings, wherein:

FIG. 1 is a side view of a typical Boeing 737 aircraft, with landing gear in the extended position, supporting the weight of the aircraft, resting on the ground, illustrating the aircraft longitudinal CG, in relation to the amount of weight supported by nose and main landing gear.

FIG. 2 is a view of a Weight and Balance Control and Loading Chart for the Boeing 737-800 aircraft of FIG. 1, illustrating the aircraft's forward and aft CG limits at various aircraft weights, where aircraft CG is identified in relation to % MAC.

FIG. 2a is a view of an exemplary polygon which is the basic starting point in the development of an aircraft weight and CG envelope.

FIG. 3 is the aircraft of FIG. 1 illustrating a more aft location of the aircraft longitudinal CG, in relation to the amount of weight supported by nose and main landing gear.

FIG. 4 is the Boeing 737-800 chart of FIG. 2 illustrating an expanded area of the aft CG envelope by eliminating main landing gear strut strength assumption limitations.

FIG. 4a is an alternate Weight and Balance Control and Loading Chart for the Airbus A-320 aircraft illustrating the aircraft's forward and aft CG limits at various aircraft weights, where aircraft CG is identified in relation to % MAC.

FIG. 4b is the chart of FIG. 4a illustrating the weight and CG limitation of the smaller and lighter Airbus A-318 aircraft (shown as the bold dashed line) are compared to the Airbus A-320 aircraft (shown as the bold solid line).

FIG. 4c is the chart of FIG. 4a illustrating the increased area beyond the current CG limitations which can be obtained by main landing gear load monitoring to eliminate concerns of main landing gear strength.

FIG. 5 is an overhead view of a typical pair of aircraft wings, further illustrating inboard and outboard wing tanks, where asymmetrical fuel loading of the wing tanks can create a lateral CG imbalance between the main landing gear.

FIG. 6 is a front view of a typical aircraft telescopic landing gear strut, further illustrating the landing gear torque-link assembly, with various elements of the preferred embodiment attached to the landing gear strut.

FIG. 7 is a side view of a typical aircraft telescopic landing gear strut, with various elements of the preferred embodiment attached to the landing gear strut.

FIG. 8 is a schematic diagram of the onboard computer with sensor inputs that support the landing gear load monitoring calculation software programs of this invention.

### DETAILED DESCRIPTION OF THE PREFERRED EMBODIMENT

The present invention offers methods of expanding the CG limits of the aircraft to allow the aircraft to be flown with higher fuel efficiency. In the description the aft CG limit is expanded. The expansion of the aft CG limit is achieved without adversely affecting the life of the landing gear struts. This is achieved through the measurement of loads applied to and experienced by the aircraft landing gear struts, throughout the cycle/load limited life of the landing gear struts, to further compare measured loads experienced by each landing gear strut to the assumed design loads designated by the aircraft manufacturer, to further increase the manufacturer's assumed nose and main landing gear strengths by means of measuring actual landing gear load data, to further expand the aircraft CG envelope at higher aircraft weights, which are currently limited by landing gear strength assumptions. An aircraft is typically supported by plural landing gear struts. In many if not most cases, the aircraft is supported by three landing gear struts. Each landing gear strut is designed much like and incorporates many of the features of a telescopic shock absorber. The shock absorber of the lauding gear strut comprises internal fluids of both hydraulic oil and compressed nitrogen gas. More simply said the weight of an aircraft rests on three pockets of compressed nitrogen gas. Pressure contained within the landing gear struts is measured in “psi”. Additionally, loads applied to the landing gear strut can be determined by monitoring strain gauge sensors which measure the mount of deflection or yielding of various structural components of the landing gear strut.

It is a misconception that aircraft landing at high vertical sink-speeds do the most damage to a landing gear, or create an extreme single-time event which would reduce the strength assumption of the landing gear to where it could no longer continue to function within safe design limitations. The landing gear uses a telescopic design which allows the landing gear to compress during a landing event, where through the telescopic compression of the landing gear, oil is forced through internal restriction orifices as internal pressures increase. The internal restriction of oil movement creates a fluid friction, which fluid friction and increased internal pressure within the contained space ultimately transfers the aircraft landing load energy into internal heat within the landing gear strut. The landing gear strut is designed to absorb and withstand these events. More damage is done to the landing gear strut before the aircraft takes-off, while internal strut pressures are their highest. Internal pressures within a main landing gear strut will reach 5,000 ^{psi} for a fully fueled and loaded aircraft, as the aircraft taxis toward the takeoff runway. As the aircraft taxis, the landing gear supports the entire aircraft load on pockets of compressed nitrogen gas. As the aircraft rolls slowly along the taxiway, then faster along the takeoff runway, the tires of the landing gear will roll across seams in the concrete surface. These seams are called “concrete expansion joints.” Some airports have very smooth taxi and runway surfaces, where other airports have rougher surfaces caused by uneven expansion joints. It is the sudden jolt of the landing gear passing over these uneven expansion joints which send severe shock loads through the aircraft tires and wheels, then transferred through the landing gear axle and ultimately into the pressurized vessel of the respective landing gear strut cylinder. At these extremely high pressure loads, with the full weight of the aircraft on the landing gear, the landing gear has diminished ability to dissipate the loads through high volumes of fluid transition through internal strut orifices; the high loads are just transferred directly to the various components of the landing gear strut. Aircraft designers cannot control at which airports an airline may choose to operate. Some airlines operate at airports with smooth taxiways and runways, while other airlines operate at less funded airports with lesser maintained, and bumpier, taxiways and runways. To avoid the potential of liability of a catastrophic failure with a landing gear strut operating at lesser maintained airports, the aircraft designers must limit the operation envelope for all aircraft they deliver to what would be assumed as the weakest link in the chain. Therefore, to reduce potential liability, the aircraft designers reduce landing gear strength assumptions to a level equivalent to a near worst case scenario. If designers had actual measured load data from each landing gear, they could compare the actual experienced loads applied to each landing year and compare the measured loads to the assumed load allocated in the landing gear strut design criteria. If the measured experienced loads are found to be less than the assumed loads, the landing gear strength assumption could be increased. If the measured experienced loads were to be more than the assumed loads, the landing gear strength assumption could be decreased, thus requiring the landing gear to be replaced at a shorter interval. In either case, the amount of fuel savings for the aircraft to be operated with further aft CG locations could allow the airline to reduce fuel costs more than the cost of replacing the landing gear.

Loads applied to the landing gear are identified by measuring the internal gas pressure within each landing gear strut. Additionally, landing gear loads can be determined by measurement of landing gear strut component yielding/bending, through monitoring output data from strain gauge sensors corresponding to changes in applied load to the respective landing gear, on various components of the landing gear strut which measure not only vertical load onto the landing gear, but side-loads as well.

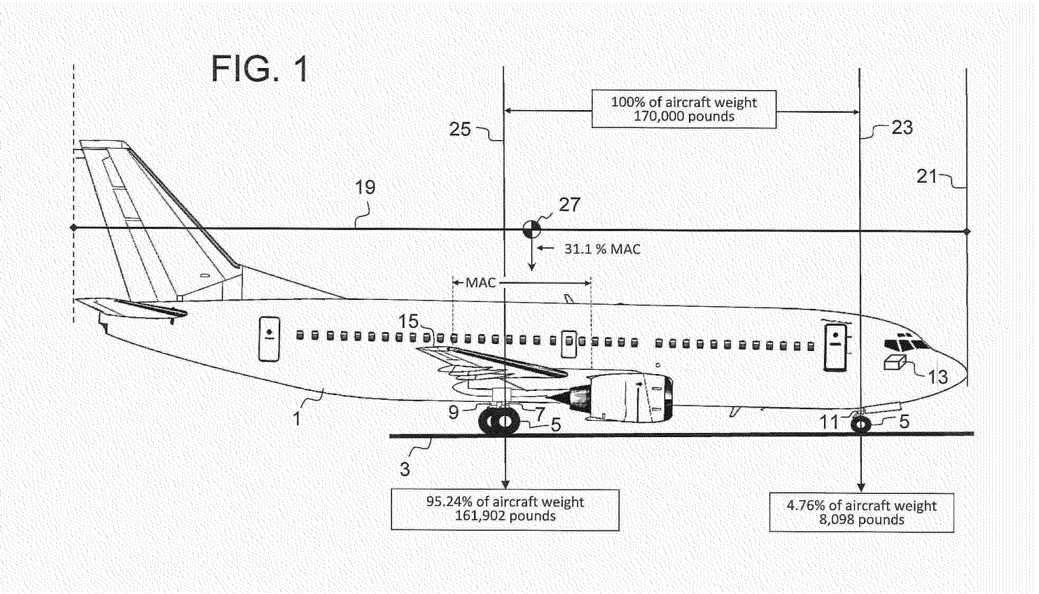

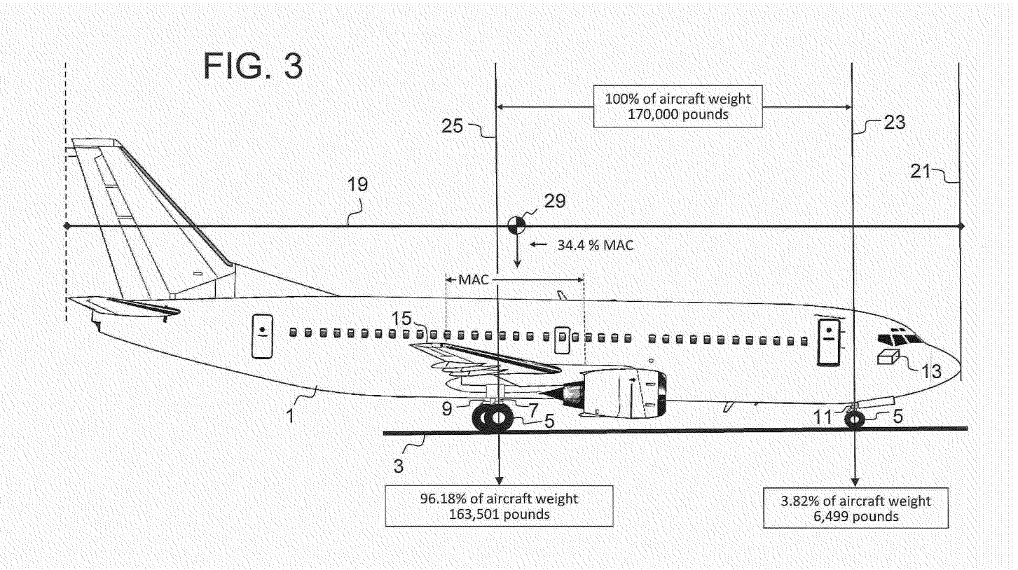

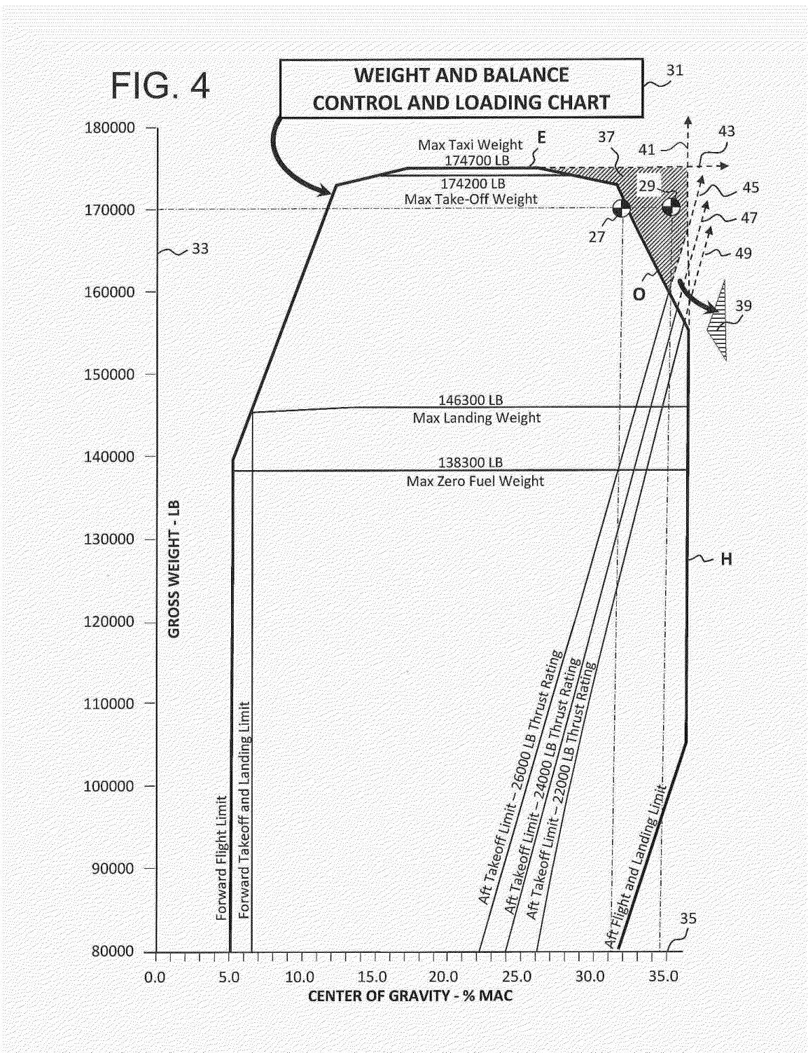

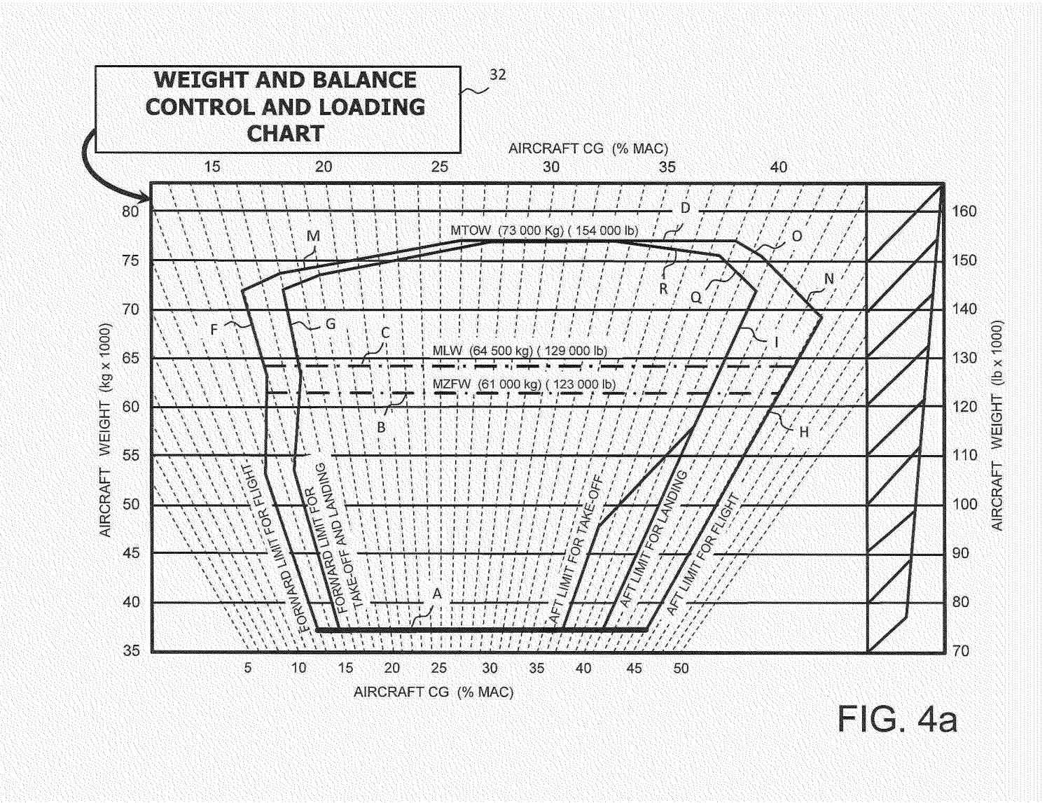

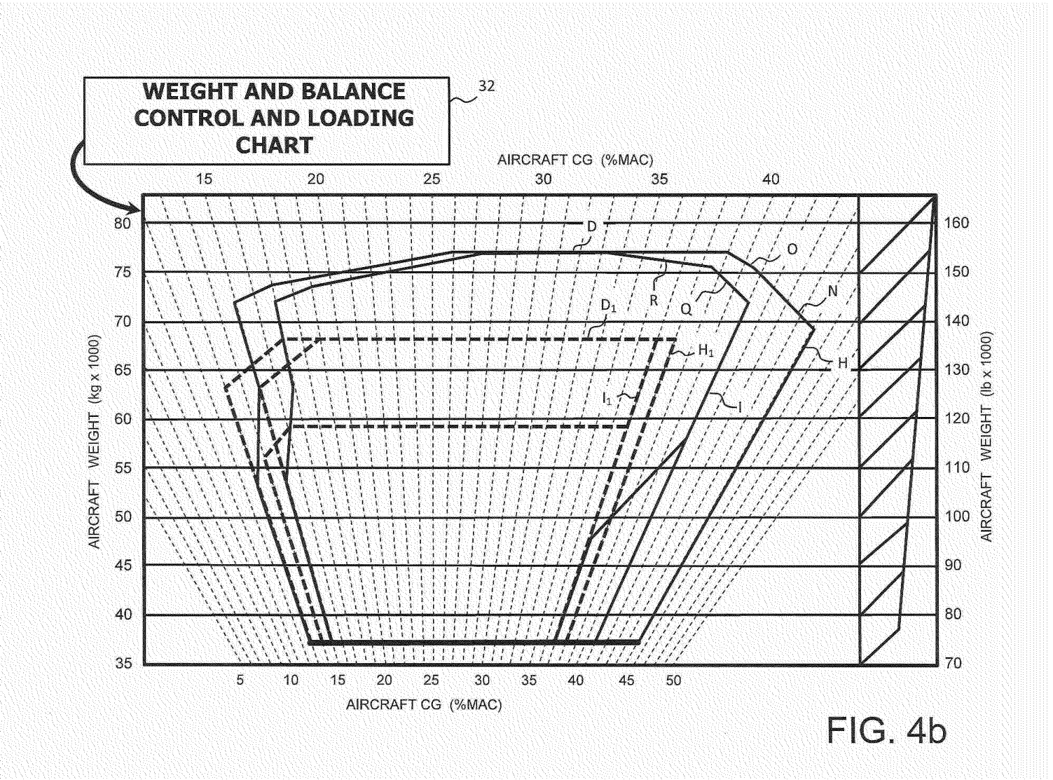

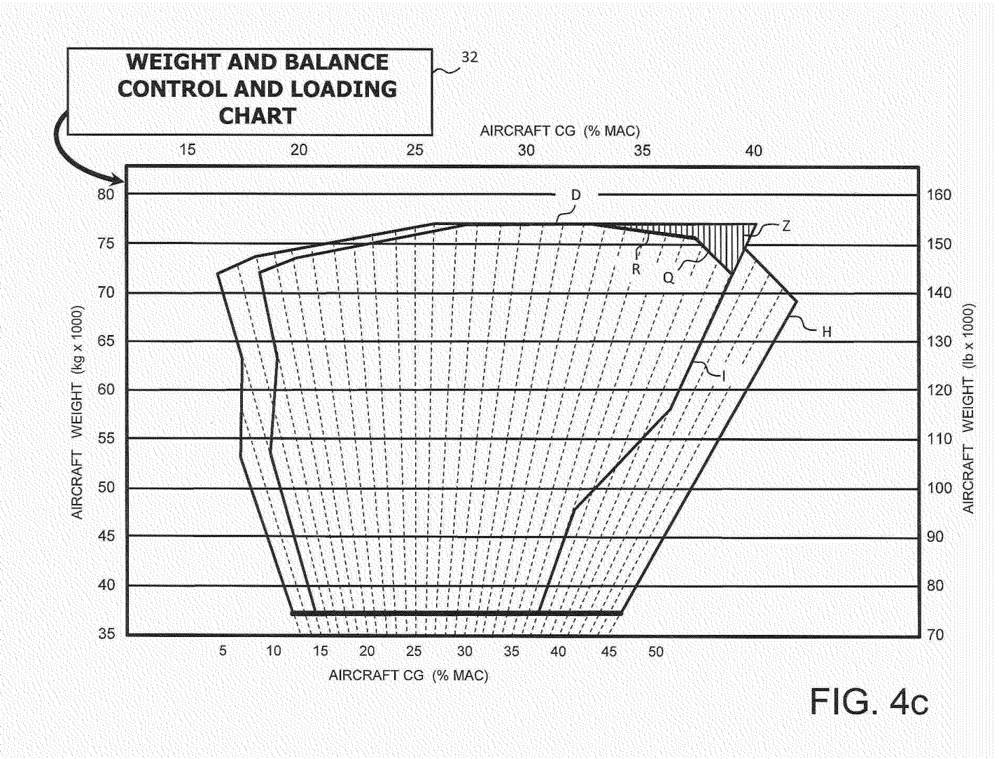

Referring now to the drawings, wherein like reference numerals designate corresponding parts throughout the several views and more particularly to FIG. 1 thereof, there is shown a typical aircraft 1. In this FIG. 1, the Boeing 737-800 aircraft is used as an example, however other types of aircraft could be used. All variations of aircraft are required to have a vertical “datum line” 21 which is a non-changeable reference point, designated by the aircraft manufacturer, which is used in calculations of the aircraft CG 27. Aircraft CG 27 (and CG 29 shown in FIG. 3 and FIG. 4) are illustrated as a round disk divided into black and white ¼ sections. (CU 27 is located inside of the aircraft 1, but in this illustration is shown above aircraft 1, for better visibility) Aircraft CG 27, as measured along aircraft longitudinal axis 19, can be referenced in various ways by different airline operations. As an example, Units of measure can be referenced in inches or in centimeters, measured aft of the aircraft datum line 21 along, the aircraft's horizontal axis 19. This form of reference is referred to as the CG 27 located at to particular “station number” for the aircraft 1. As an additional example, the location of aircraft CG 27 may be referenced at a location measured as a percentage of the distance from the leading edge of the aircraft's Mean Aerodynamic Chord (% MAC). MAC is the “average” (Mean) width of aircraft 1 wing's 15 lifting surface (Aerodynamic Chord). In the case of the swept-wing 15 of aircraft 1, the leading edge of MAC is located just aft of the leading edge of the wing 15 where it attaches to the aircraft 1. The trailing edge of the MAC is located just forward of the aft tip of wing 15. Airline operations often reference the aircraft CG location as at a position located some percentage aft of the forward edge of the mean aerodynamic chord, or as % MAC.

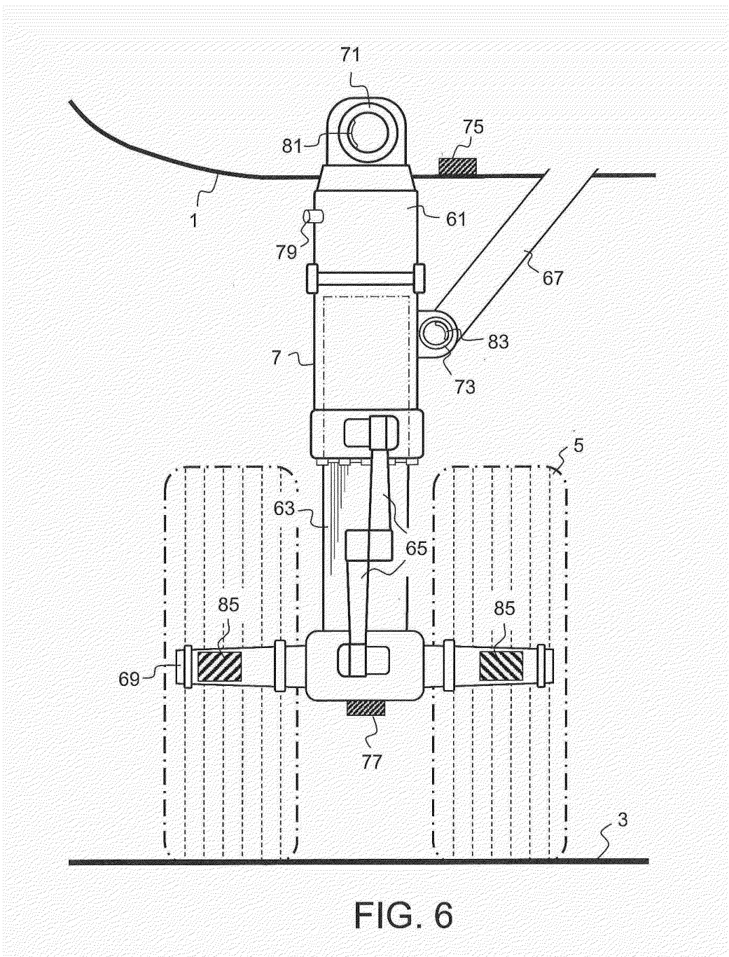

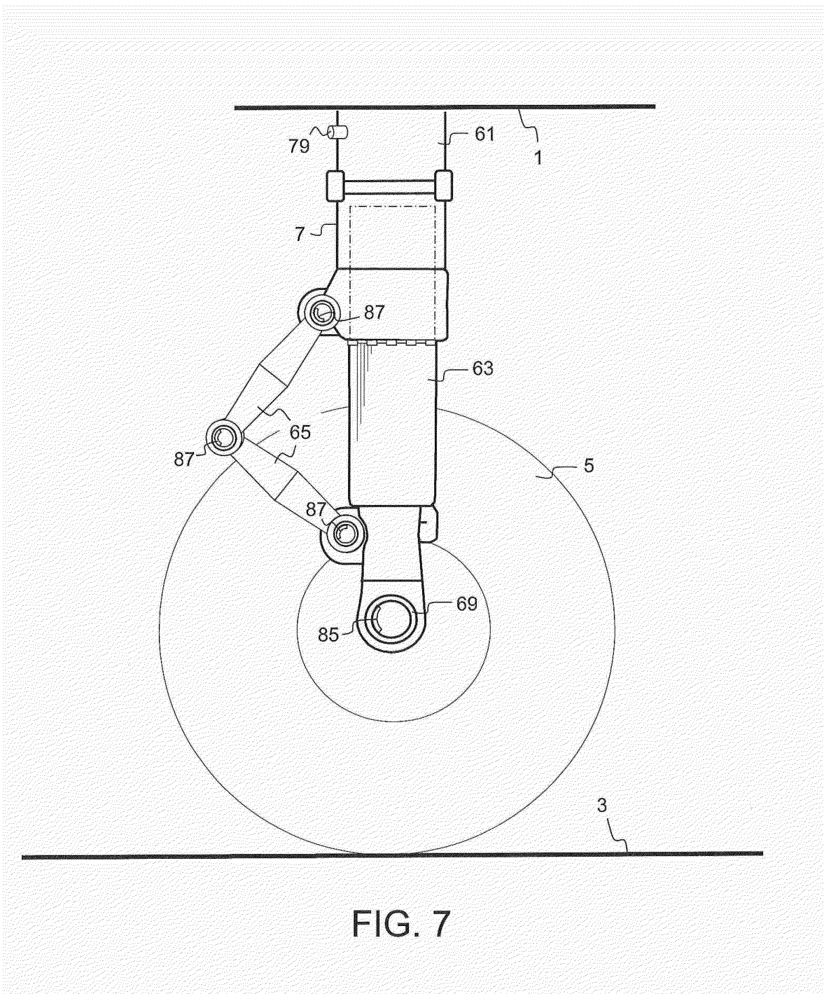

Aircraft 1 has a tricycle landing gear configuration consisting of a nose landing gear 11, and also two identical main landing gears including a right main landing gear 7 and a left main landing gear 9. Main landing gears 7 and 9 are located at the same point along the aircraft's horizontal axis 19, but for convenience in this illustration, are shown in a perspective view for this FIG. 1. With this tricycle landing gear configuration, the aircraft CG 27 is located at some distance all of the nose landing gear 11, and must always be positioned forward of main landing gear 7. If CG 27 is allowed to move aft of main landing gear 7, aircraft 1 will tip aft. Landing gear 7, 9 and 11 incorporate one or more wheel and tire 5 to distribute the weight of aircraft 1 which is resting on the ground 3. Vertical line 23 identifies the centerline of the vertical load applied to nose landing gear 11. Vertical line 25 identifies the centerline of the vertical load applied to the combined main landing gears 7 and 9. Electronic elements which together are used in this invention, attached to aircraft 1, are an aircraft landing gear load monitoring computer 13 which receives measured landing gear load data inputs from landing gear strut pressure sensors 79 with embedded temperature probes and various strain gauge sensors 81, 83, 85, 87 attached to various landing gear load bearing components, which measure both vertical and side loads applied to landing gear 7 (sensors are shown in FIGS. 6 and 7). Computer 13 contains various internal circuit boards for processing calculations for respective landing gear loads. In the example of FIG. 1, aircraft CG 27 is located at 31.1% MAC, which has 95.24% (161,902 pounds) of the aircraft's total 170,000 pound weight being supported by the combined right and left main landing gears 7 and 9. The remaining 4.76% (8,098 pounds) of the aircraft weight is supported by nose gear 11.

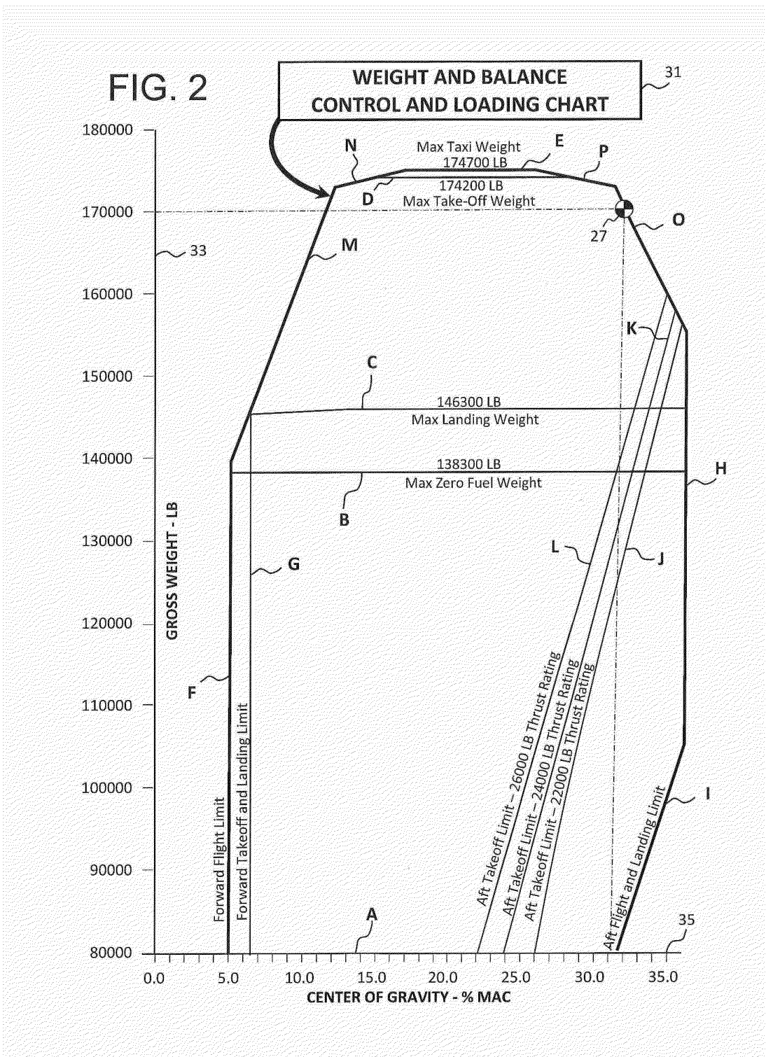

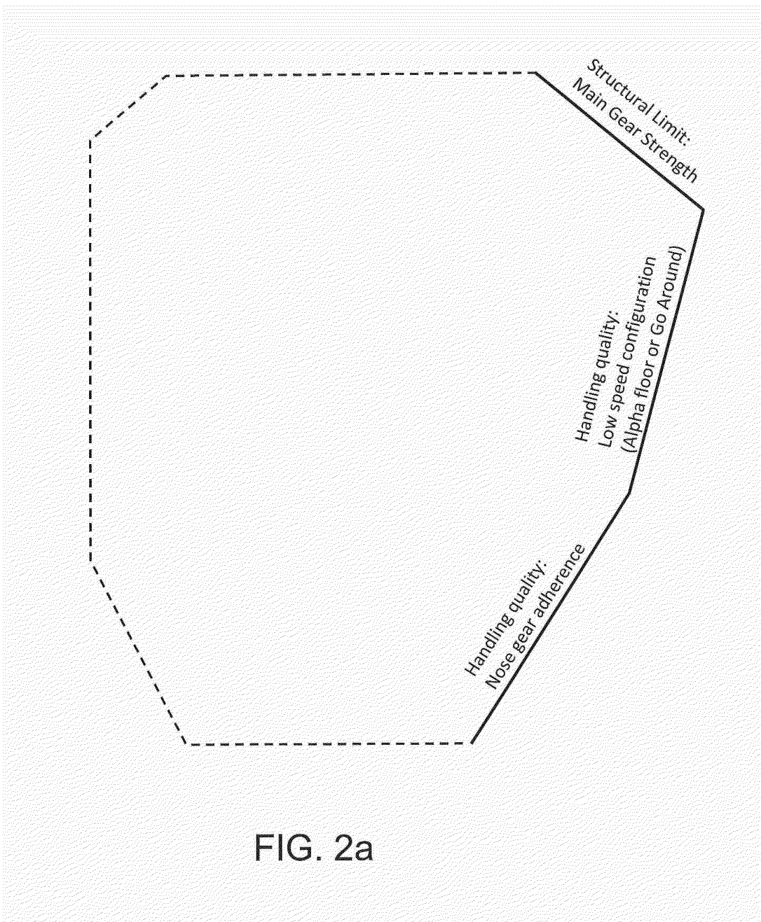

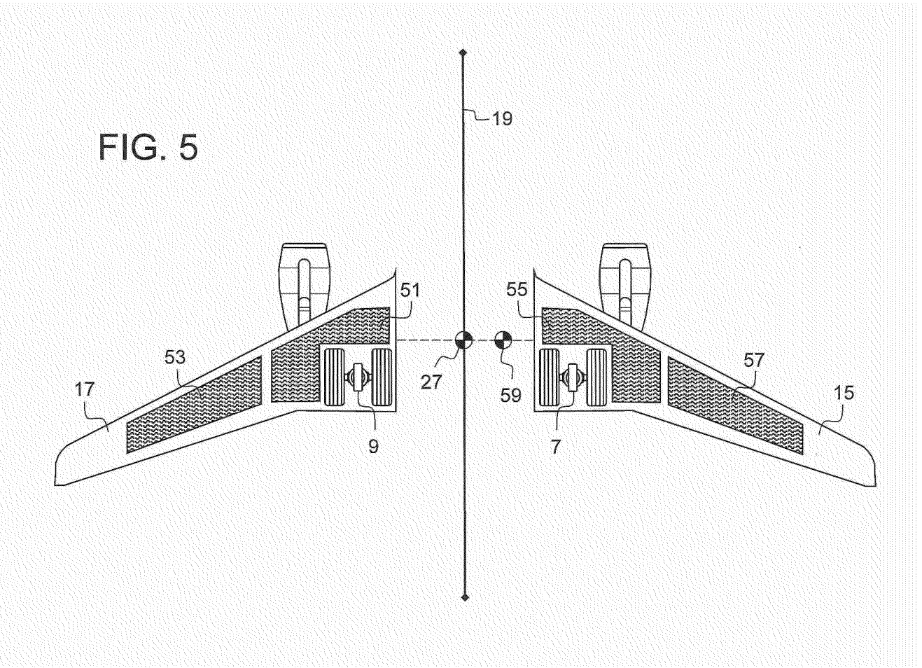

Referring now to FIG. 2, there is shown an aircraft Weight and Balance Control Loading Chart 31 for the Boeing 737-800 aircraft. Chart 31 has a vertical axis 33 representing increases in aircraft gross weight, and a horizontal axis 35 (also represented by line A) for identification of the aircraft's forward and aft CG 27 location, where in this example the aircraft weight is 170,000 pounds and aircraft CG 27 is located at 31.1% of the aircraft's Mean Aerodynamic Chord (% MAC). Aircraft weight will typically continue to increase vertically along weight axis 33 as the aircraft is loaded. Aircraft CG 27 will fluctuate forward and aft in relation to horizontal axis 35 as passengers enter the aircraft from the front door and move aft to their respective seats. The CG 27 will also move or shift as cargo is loaded into the aircraft cargo compartments, typically located beneath the passenger compartment. The seating arrangement of the passengers, the distribution a cargo in the holds and the use of certain inboard and outboard fuel tanks (shown in FIG. 5) can be used to move or re-locate CG 27 to a desired position. Weight and Balance Chart 31 creates an envelope in which the aircraft can safely operate. There are a number of factors which must be considered when the aircraft designer defines the aircraft CG limitations, being the outside boundaries of the weight and CG envelope. The creation of a weight and CG envelope can be considered as compiling layers of multiple limitation envelopes, being overlaid atop of each other, to determine the full limitations chart. Reference again made to the Airbus Aircraft Industries, Customer Services—Flight Operations Support & Line Assistance “Getting to Grips with Weight and Balance” publication. Pages 104-105. To begin this process we start with a list of limitations shown as lines which connected together to define the outer boundaries of the weight and CG envelope, as well as additional limitations located within the envelope.

List of weight and CG limitation lines:
A. basic empty weight of the aircraft;
B. max zero fuel weight, a structural limitation, being the maximum allowable weight of the aircraft, with zero fuel loaded into the fuel tanks;
C. max landing weight, a structural limitation, being the maximum allowable aircraft weight during landing, predicated on an “ultimate landing sink-speed” (vertical velocity) of an assumed 10 feet per second;
D. max takeoff weight, a structural limitation, predicated on the lift capacity of the aircraft wings;
E. max taxi weight, a structural limitation, allowing for additional fuel weight to be carried during taxi, and must be consumed thus removed, allowing aircraft weight to fall below the max takeoff weight, prior to takeoff;
F. forward flight CG limit, a handling and stability limitation, to avoid the nose being too heavy for stable flight;
G. forward takeoff and landing CG limit, a handling and stability limitation, to avoid the nose being too heavy for rotation at takeoff;
H. aft flight CG limit, a handling and stability limitation, to avoid the nose being too light for stable flight, thus avoiding a possible aircraft stall during takeoff and flight;
I. aft flight and landing limit, a handling and stability limitation, at lower weights CG must be curtailed to allow sufficient nose landing gear adherence to the ground to aide aircraft steering during taxi, and avoid upward nose drift during flight, and avoid tail-strike during landing;
J. 22000 LB thrust rating, a handling and stability limitation, as the engines induce thrust the aircraft CG will shift aft. The aft CG limit is curtailed to avoid aircraft tipping and tail-strike during takeoff;
K. 24000 LB thrust rating, a handling and stability limitation, as the engines induce higher thrust the aircraft CG will shift aft. The aft CG limit is additionally curtailed to avoid aircraft tipping and tail-strike during takeoff;
L. 26000 LB thrust rating, a handling and stability limitation, as the engines induce even higher thrust the aircraft CG will shift aft. The aft CG limit is additionally curtailed to avoid aircraft tipping and tail-strike during takeoff;
M. forward CG curtailment as aircraft weight increases, a structural limitation, to avoid excess loads being applied to the nose landing gear;
N. forward CG curtailment as aircraft weight nears max-weight limitations, a structural limitation, to avoid excess loads being applied to the nose landing gear;
O. aft CG curtailment as aircraft weight increases, a structural limitation, to avoid excess loads being applied to the main landing gear;
P. aft CG curtailment as aircraft weight nears max-weight limitations, a structural limitation, to avoid excess loads being applied to the main landing gear.

Referring now to FIG. 3, there is shown the identical aircraft as shown in FIG. 1, but with CG 29 located slightly further aft along aircraft longitudinal axis 19, at 34.4% MAC; where in this example 96.18% (163,501 pounds) of the aircraft's total 170,000 pound weight is being supported by the combined right and left main landing gears 7 and 9. The remaining 3.82% (6,499 pounds) of the aircraft weight is supported by nose gear 11. In a closer comparison of the example of FIG. 1 to the distributed weights supported by main and nose landing gear in FIG. 3, reveal that in the FIG. 3 the mere 3.3% MAC further aft positioning of CG 29 increases the weight supported by the main landing gears 7 and 9 by only 0.98% (1,599 pounds). With less than 1% increase in the assumed loads applied to the main landing gears 7 and 9, the aircraft 1 can be safely operated with more fuel efficiency.

Referring now to FIG. 4, there is shown the identical Weight and Balance Control and Loaning Chart shown in FIG. 2, but with an alternate example of CG, now CG 29 which is located farther aft, at 34.4% MAC, corresponding to the aircraft of FIG. 3. CG 29 is located within shaded area 37 which identifies an extended area of the weight and CG limitations, without exceeding the aircraft's maximum weight limitation shown by the continuation of line E by horizontal dashed arrow 43, as well as not exceeding the aircraft's handling and stability limitation, shown by the continuation of line H, by vertical dashed arrow 41. Shaded area 37 is curtailed for various engine performance limitations identified by dashed arrows 45, 47, 49 which each curtail the aft CG limitations for various engine thrust ratings used during the takeoff roll. Shaded area 39 represents a potential reduction in curtailment of shaded area 37 due to a decrease in engine thrust during the takeoff roll. When using lower engine thrust ratings, shaded area 39 can be utilized to allow aircraft CG positioning within this area, still without exceeding the aircraft's handling and stability limitation, as shown by the extension of line H, by vertical dashed arrow 41. To allow utilization of shaded area 37 for location of aircraft CG 29 the airline would be required to use landing gear load monitoring sensors and computer (shown in FIGS. 6-8) which verify actual loads applied to each respective landing gear, to compare applied loads to assumed loads, through the life cycles of the landing gear to further demonstrate landing gear strength has not been degraded beyond aircraft design assumptions. The load data is measured and stored in the computer 13. If an airline's operations of a particular aircraft discover excessive measured landing gear loads, which would indicate a potential infringement into the landing gear strength assumptions; shaded area 37 would then be restricted from further use until such landing gear is removed, examined or replaced, followed by continued monitoring of loads on the replaced landing gear to assure applied loads remain below the landing gear strength assumptions.

The effect of CG on landing gear during taxi and takeoff can not only be monitored along the longitudinal axis of the aircraft, it can be monitored laterally as well.

Referring now to FIG. 4a, there is shown an aircraft Weight and Balance Control Loading Chart 32 for the Airbus A320-212 aircraft. The Airbus Chart 32 is a similar and corresponding chart for illustrating aircraft CG, to that for the Boeing 737-800 Chart 31 illustrated in FIG. 2. One obvious difference in the Airbus Weight and Balance Control Chart 32 is the greater separation of the % MAC values at the top of the chart, as compared to the lesser separation of the % MAC values at the bottom of the chart. Though the lines are vertical in the center of the chart, and begin to progressively tend to slant towards the outer values; this Airbus Chart 32 is used in the same manner to illustrate aircraft CG, as the Boeing Chart 31, in FIG. 2. The weight and balance limitations for the Airbus A320-212 are illustrated in the same way as with the Boeing aircraft of FIG. 2 where:
A. basic empty weight of the aircraft,
B. max zero fuel weight,
C. max landing weight,
D. max takeoff weight,
F. forward flight CG limit;
G. forward takeoff and landing CG limit,
H. aft flight CG limit,
I. aft flight and landing limit,
M. forward CG curtailment as aircraft weight increases,
N. forward CG curtailment as aircraft weight nears max-weight limitations,
O. aft take-off CG curtailment as aircraft weight increases,
P. aft take-off CG curtailment as aircraft weight nears max-weight,
Q. aft landing CG curtailment as aircraft weight increases,
R. aft landing CG curtailment as aircraft weight nears max-weight.

Referring now to FIG. 4b there is shown the identical Weight and Balance Control and Loading Chart 32 shown in FIG. 4a, with an overlaid illustration of the weight and balance limitations of the smaller and lighter Airbus A-318; shown by the hold dashed lines. Bold dashed line D₁ represents the lower Max Take-off Weight limitation for the A-318. Bold dashed line H₁ represents the A-318's aft CG limit for Take-off. Bold dashed line I₁ represents the A-318's aft CG limit for Landing. The lighter A-318 aircraft is a derivative of the A-320 family of aircraft and though the aircraft is substantially lighter, the A-318 uses the same main landing gear as the A-320 aircraft. The same landing gear used on this lighter aircraft removes the high weight all CG limitation curtailment shown by the A-320 solid line Q, and even higher weight aft CG curtailment shown by the A-320 solid line R. The use of the A-320 main landing gear on the lighter A-318 results in a more robust landing gear design for that lighter aircraft model. If the heavier A-320 aircraft had a more robust main landing gear design, it too would not have the aft CG curtailments associated with main landing gear strength assumptions. A remedy for the lack of a more robust main landing gear for the A-320 aircraft, is the use of a landing gear load monitoring system to measure and verify that the aircraft manufacture's assumed landing gear loads are less than the loads actually experienced, thus allowing the justification basis to eliminate the aft CG curtailments for the A-320 aircraft with the recording of measured landing gear load data.

Referring now to FIG. 4c, there is shown the identical Weight and Balance Control and Loading Chart 32 shown in FIG. 4a, with many of the superfluous weight and CG limitation lines removed, to allow for a better illustration of an expanded A-320 aft CG zone Z, located at the of boundary of the current CG limitations at higher aircraft weights. With the removal of main landing gear strength assumptions and replacement with measured main landing gear load data, the current aft CG limitations shown by lines Q and R may be removed allowing the current Max Take-off Weight limitation line D to continue aft to a point where it intersects with the extension of the extended aft CG limit for landing line I. This newly created portion of the weight and Balance Control and Landing Chart 32 will be referred to as expanded aft CG zone Z.

Referring now to FIG. 5, there is shown an overhead view of a pair of typical aircraft wings 15 and 17. Some aircraft have and utilize a center fuel tank, located within the center-belly of the aircraft (not shown) and such tank shall be recognized as not used in this example. Right aircraft wing 15 holds 50% of the fuel used during a flight, which fuel is distributed within inboard fuel tank 55 and outboard fuel tank 57. Left aircraft wing 17 holds the remaining 50% of the fuel used during a flight, which this remaining fuel is distributed within inboard fuel tank 51 and outboard fuel tank 53. When the fuel load is equally balanced between right wing 15 and left wing 17 the lateral position of CG 27 will be located along aircraft longitudinal axis 19. When the fuel load is not balanced between right wing 15 and left wing 17, where as an example a higher percentage of fuel is contained within right wing 15 inboard fuel tank 55 and/or outboard fuel tank 57, aircraft CG 59 will become laterally asymmetrical. Laterally asymmetrical CG 59 can apply higher loads to right main landing gear 7. The load monitoring capabilities of this invention allows for the tracking of any asymmetrical main landing gear loads, throughout the life cycle limitation of the landing gear.

Referring now to FIG. 6. there is shown a front view of a typical aircraft telescopic landing gear strut 7, further identifying landing gear strut cylinder 61, in which strut piston 63 moves telescopically. Pressure and temperature within main landing gear 7 are monitored by a pressure/temperature sensor 79. Ground 3 loads transferred to wheel and tire 5 are subsequently transferred through axle 69 to strut piston 63. Deflection of axle 69 from applied ground load is measured by strain gauge sensor 85. As aircraft 1 taxi, takes-off and lands; side loads against landing gear 7 are restrained by side-brace 67. Side loads applied to landing gear 7 are transferred to side-brace 67 through a connection trunion pin 73. The side loads experienced by landing gear 7 can be measured by strain gauge sensor 83, attached to side-brace trunion pin 73. As aircraft 1 taxi, takes-off and lands, strut piston 63 is restricted from rotating within strut cylinder 61 by a torque-link (scissor-link) 65. As aircraft 1 taxi, takes-off and lands, vertical and horizontal acceleration of the aircraft 1 is measured by accelerometer 75 which is attached to a lower fuselage section of aircraft 1. As aircraft 1 taxi, take-off and land, the different amount of vertical and horizontal acceleration of the lower portion of telescopic landing gear is measured by lower landing gear accelerometer 77. Not all of the sensors are required. For examples, only pressure sensors can be used without the use of strain gauges and accelerometers.

Referring now to FIG. 7, there is shown a side view of a typical aircraft telescopic landing gear strut 7. Loads applied to torque-link 65 are measured by strain gauge sensors 87, at the three separate hinge points of torque-link 65.

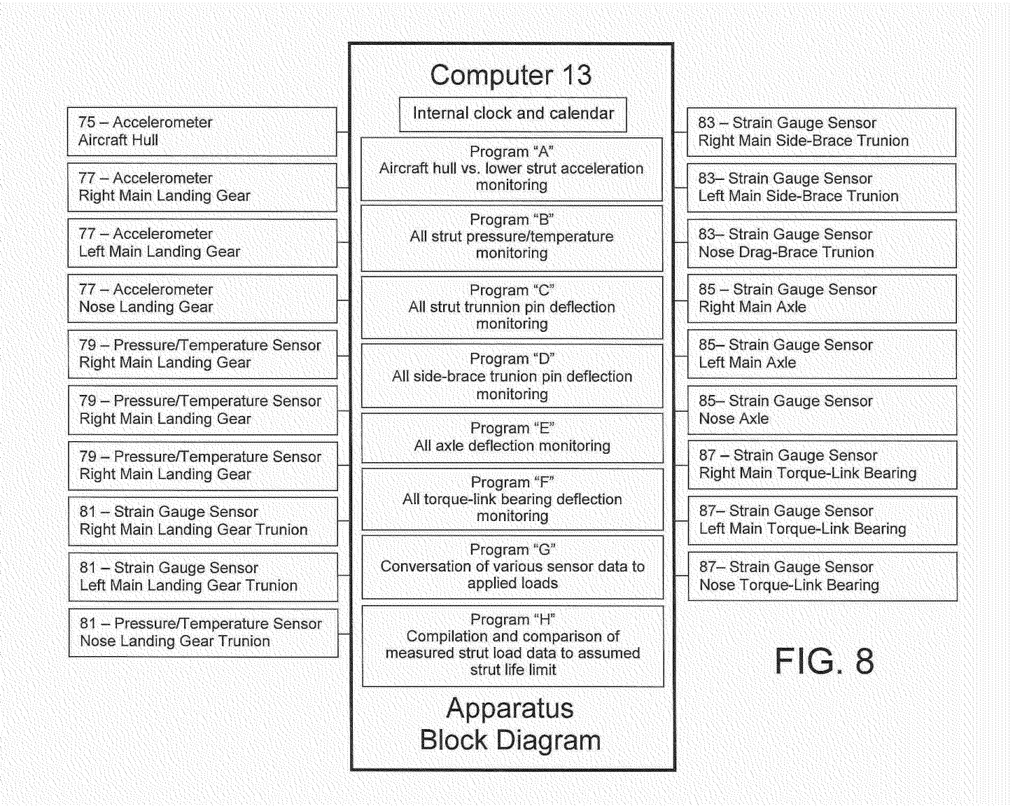

Referring now to FIG. 8, there is shown a block diagram illustrating the apparatus and software of the invention, with multiple (nose, left-main and right-main landing gear) pressure/temperature sensors 79 which supply landing gear strut pressure/temperature data into CG computer 13. Additionally, aircraft hull accelerometer 75 and lower landing gear accelerometers 77, combined with multiple (nose, left-main and right-main landing gear) strain gauge sensors 81, 83, 85, 87 supply voltage data corresponding to aircraft acceleration, landing gear strut axle deflection, strut trunion pin deflection, side-brace trunion pin and torque-link bearing deflections; to CG computer 13. Computer 13 is equipped with an internal clock and calendar to document the time and date of stored data, as well as memory to store the data and the software packages. Computer 13 also has an input/output interface to allow the downloading of data, either wirelessly or by a wire, to another device or computer.

Computer 13 has multiple software packages which include:
Program “A”—a software routine for monitoring aircraft hull acceleration, as compared to lower landing gear strut acceleration, as the aircraft taxi before takeoff. Landing gear strut loads are monitored in relation to the Kinetic Energy dissipated as extreme load is suddenly applied to the landing gear, as it might bit a hump on the runway. Kinetic Energy is defined as ½ the Mass times Velocity². The velocity element of this equation is better measured and defined by collection of acceleration data which measure both aircraft huh movement, as well as the compression rate of the landing gear strut by comparison of acceleration of the aircraft hull to that of the acceleration of the lower portion of the landing gear strut. Acceleration data is used as cross-reference data when compared to strut pressure data and deflection sensor data, to farther determine dynamic loads applied to respective landing gear struts. Measurement of landing gear strut rate of compression as measured by acceleration is a disclosure of U.S. Pat. No. 8,042,765 the entire disclosure of which is incorporated by reference.
Program “B”—a software routine for monitoring aircraft landing gear strut pressure. Strut pressure can be converted into the vertically applied strut load. High pressure within each landing gear create higher temperatures, which induce artificially higher measured pressure. Temperature compensations are made to correct measured strut pressures as proportional to supported load on each respective lauding gear strut. Corrected pressure distortions related to temperature and landing gear strut seal friction errors are disclosures of U.S. Pat. Nos. 5,214,586 and 5,548,517 the entire disclosures of which are incorporated by reference.
Program “C”—a software routine for strain gauge sensor monitoring of the deflection of aircraft landing gear strut fruition pin connections to the aircraft hull. Strain gauge sensor voltage changes can be converted to the applied load which deflect the trunion pin.
Program “D”—a software routine for strain gauge sensor monitoring of the deflection of aircraft landing gear side-brace trunion pin connections from the aircraft hull to the landing gear strut cylinder. Strain gauge sensor voltage changes can be converted to the applied load which deflect the trunion pin.
Program “E”—a software routine for strain gauge sensor monitoring of the deflection of aircraft landing gear axles. Strain gauge sensor voltage changes can be converted to the applied load which deflect the axles.
Program “F”—a software routine for strain gauge sensor monitoring of the deflection of aircraft landing gear torque-link hinge bearings. Strain gauge sensor voltage changes can be converted to the applied load which deflect the torque-link hinge pins.
Program “G”—a software routine where multiple look-up tables are generated and subsequently used to convert measured: aircraft hull acceleration vs. lower landing gear strut acceleration to determine strut compression, internal strut pressure corrected for internal strut temperature as related to experienced vertical loads; further compared to strain gauge sensor voltage changes related to respective deflections of various landing gear components, to monitor and measure vertical and side loads to the aircraft landing gear struts.
Program “H”—a software routine for identifying various loads applied to the aircraft landing gear and further create a load history of measured loads experienced over the actual life of the landing gear; to further compare actual loads experienced by each respective landing gear against the assumed loads which would have been applied to the respective landing gear at that point of the landing gear expected life; to identify any potential of lesser loads being applied to the landing gear than anticipated loads, to further create a justification basis for allowing the aft CG limitation of the aircraft weight and CG envelope be extended proportionally to the actual loads experienced; which further demonstrated landing gear strength assumptions may be relieved or removed. Such a comparison allows identification of any exceedance, where measured loads exceed anticipated or assumed loads.

An example of the Program “H” is as follows: strut loads can be monitored throughout various phases of aircraft operation. For example, strut loads can be monitored at all times that the aircraft is on the ground. Alternatively, strut loads can be monitored before and during takeoff. As still another alternative, strut loads can be monitored before and during takeoff if the CG 29 is located beyond the landing gear “assumed strength” curtailment (referring to FIG. 4, area 37 shows an example). The CG can be determined in accordance with conventional techniques, such as discussed in U.S. Pat. No. 5,214,586. If the CG 29 is beyond the landing gear “assumed strength” curtailment (line O of FIG. 4), then the loads on the landing gear during taxi and takeoff can be monitored. The CG can be determined at the gate, as the aircraft is being loaded. If the CG 27 is within the envelope as shown in FIG. 4, then the landing gear strut loads need not be monitored. However, the loads may be monitored to accumulate historical load data on the struts.

When monitoring the loads during taxi and on a takeoff, the loads can be monitored by internal strut pressure, acceleration of selected components or strain of selected components. This load information is stored in memory in the computer 13. The location of the CG is also recorded.

Once the aircraft is airborne, the landing gear strut loads no longer need to be monitored. The aircraft is operated in flight. If the CG 29 is beyond the landing gear curtailment (FIG. 4, line O; in area 37), then such operations typically mean that the aircraft is flown with a reduced trim profile, and the aircraft flies more efficiently, consuming less fuel. A reduced trim profile produces less aerodynamic drag while the aircraft is in flight.

Monitoring the strut loads while the aircraft taxi and on takeoff allows several options. The strut load information and CG information is analyzed over a history of flight operations of that particular aircraft to determine if the struts are experiencing taxi and takeoff loads that are higher than a predetermined amount or lower than the predetermined amount. The predetermined amount of loading is typically the assumed loads. If the loads are less than the predetermined amount, the aircraft can continue to be operated on subsequent flights with its CG beyond the landing gear strength limitation. If the loads are greater than the predetermined amount, the aircraft can be curtailed in its operations so that the CG 27 is within the line O of FIG. 4. Alternatively, the aircraft can continue to be operated on subsequent flights with its CG beyond the landing gear strength limitations (in area 37). Based on the load monitoring, the actual life of the landing gear can be determined relative to the assumed life (for example 80,000 cycles). If the landing gear ages prematurely due to higher than expected loads, then a replacement landing gear can be substituted accordingly. An aircraft operator may choose this latter option if the fuel savings is enough to offset the cost of replacing the landing gear. Alternatively, if the loads are greater than the determined amount, the aircraft can be operated with its CG within or closer to the landing gear strength limitation, so as to obtain more landing cycles and subsequent longer life for the landing gear strut.

Although the aircraft described herein is a passenger aircraft, the invention can be used on cargo aircraft. Although the aircraft is discussed as flying with its CG beyond the “assumed strength” landing gear limitations, the CG is located within the CG limitations of safe handling (for example, within, or forward of, line H of FIG. 2). Also, although the CG has been discussed as moving aft, beyond the main landing gear “assumed strength” limitation, the CG could be moved forward beyond the nose gear “assumed strength” limitation (line M in FIG. 2), but still within, or aft of, line F for safe handling purposes.

Additionally, as an exemplary embodiment of the invention has been disclosed and discussed, it will be understood that other applications of the invention are possible and that the embodiment disclosed may be subject to various changes, modifications, and substitutions without necessarily departing from the spirit and scope of the invention.

1. A method of expanding a center of gravity (CG) limitation of an aircraft, the aircraft having landing gear struts, the aircraft having a first CG limitation that is determined by a designer of the aircraft, the first CG limitation based upon assumed loads on the landing gear struts, comprising the steps of:
a) operating the aircraft;
b) during the operation of the aircraft, measuring the loads on the landing gear struts;
c) determining if the measured loads have exceeded the assumed loads;
d) if the measured loads have not exceeded the assumed loads, then determining a second CG limitation that exceeds the first CG limitation;
e) operating the aircraft at an expanded CG which exceeds the first CG limitation but is within the second CG limitation.

2. The method of expanding a center of gravity (CG) limitation of an aircraft of claim 1, wherein the step of measuring the loads on the landing gear struts further comprises measuring the pressure in the landing gear struts.

3. The method of expanding a center of gravity (CG) limitation of an aircraft of claim 1, wherein the step of measuring the loads on the landing gear struts further comprises measuring acceleration of the landing gear struts.

4. The method of expanding a center of gravity (CG) limitation of an aircraft of claim 1, wherein the step of measuring the loads on the landing gear struts further comprises measuring strain in the landing gear struts.

5. The method of expanding a center of gravity (CG) limitation of an aircraft of claim 1, further comprising the step of continuing to measure the loads on the landing gear struts while operating the aircraft at the expanded CG to determine a load history of the landing gear struts.

6. The method of expanding a center of gravity (CG) limitation of an aircraft of claim 5, further comprising the step of comparing the measured loads applied on the landing gear struts to the assumed loads on the landing gear struts, to further identify any exceedance.

7. The method of expanding a center of gravity (CG) limitation of an aircraft of claim 6, further comprising the step of comparing the measured loads on the landing gear struts with the assumed loads on the landing gear struts, to verify landing gear strength assumptions have not be reached nor exceeded.

8. The method of expanding a center of gravity (CG) limitation of an aircraft of claim 1, wherein if the measured loads have exceeded the assumed loads, then reducing a life limit of the landing gear struts or reducing the expanded CG limitation.

9. The method of expanding a center of gravity (CG) limitation of an aircraft of claim 1, wherein the first and second CG limitations are aft CG limitations.

10. The method of expanding a center of gravity (CG) limitation of an aircraft of claim 1, wherein operating the aircraft at the expanded CG consumes less fuel than operating the aircraft at a CG that is within the first CG limit.
